(19) United States
(12) Patent Application Publication
(10) Pub. No.: US 2016/0342055 A1
(43) Pub. Date: Nov. 24, 2016

(54) LIQUID CRYSTAL DISPLAY PANEL

(71) Applicant: SHENZHEN CHINA STAR OPTOELECTRONICS TECHNOLOGY CO.,LTD., Shenzhen, Guangdong (CN)

(72) Inventor: Meng WANG, Shenzhen, Guangdong (CN)

(73) Assignee: Shenzhen China Star Optoelectronics Technology Co., Ltd., Shenzhen, Guangdong (CN)

(21) Appl. No.: 14/424,016

(22) PCT Filed: Feb. 9, 2015
(86) PCT No.: PCT/CN2015/072492

§ 371 Date: Feb. 25, 2015

(30) Foreign Application Priority Data
Dec. 8, 2014 (CN) 201410742733.2

(51) Int. Cl. G02F 1/1362; G02F 1/1335; G02F 1/1333; G02F 1/1368

(52) U.S. Cl. CPC G02F 1/136286; G02F 1/1368; G02F 1/133514; G02F 1/133528; G02F 1/133345; G02F 2201/121; G02F 2201/123; G02F 2001/133531

(57) ABSTRACT

The present invention provides a liquid crystal display panel including a gate line (G1) and a data line (S1) that are respectively inclined with respect to a first direction (D1) and a second direction (D2) and also including a pixel electrode (40) having trunks (401) parallel with the gate lines (G1). The pixel electrode (40) has branches (402) parallel with a slope section (S11) of the data line (S1). Liquid crystal molecules are arranged to have an orienting direction that is different from the first direction (D1) or the second direction (D2) and is inclined with respect to the first direction (D1) or the second direction (D2). Correspondingly arranged incidence polarizer (13) and exit polarizer (23) have transmission axes in directions that are different from the first direction (D1) and the second direction (D2), so that visibility of an image displayed on the panel is not affected as being observed by a user through a polarizer element, such as polarizer sunglasses, having a transmission axis in a direction that is identical to the first or second direction (D1, D2) thereby improving the visibility of the image displayed on the liquid crystal display panel.

### BACKGROUND OF THE INVENTION

1. Field of the Invention

The present invention relates to the field of displaying technology, and in particular to a liquid crystal display panel.

2. The Related Arts

With the development of the displaying technology, liquid crystal displays (LCDs), which have various advantages, such as high image quality, low power consumption, thin device body, and wide applications, have been widely used in various electronic consumer products, such as mobile phones, televisions, personal digital assistants (PDAs), digital cameras, notebook computers, and desktop computers, and become the main stream of the display devices.

Most of the liquid crystal displays that are currently available in the market are backlighting liquid crystal displays, which comprise an enclosure, a liquid crystal panel arranged in the enclosure, and a backlight module mounted in the enclosure.

A conventional liquid crystal display panel is formed by laminating a thin-film transistor (TFT) array substrate and a color filter (CF) substrate. A pixel electrode and a common electrode are respectively formed on inside surfaces of the TFT substrate and the CF substrate. Liquid crystal is filled between the TFT substrate and CF substrate. The principle of operation is that a driving voltage is applied between the pixel electrode and the common electrode and an electric field established between the pixel electrode and common electrode is used to control the rotation of the liquid crystal molecules contained in the liquid crystal layer for refracting out light from the backlight module to generate an image. Such a liquid crystal display panel structure is used in liquid crystal display panels of twisted nematic (TN) mode, electrically controlled birefringence (ECB) mode, and vertical alignment (VA) mode. Often, the liquid crystal display panels of this structure have a narrow view angle.

To expand the view angle of the liquid crystal display panels, a display mode in which a horizontal electric field is applied to the liquid crystal layer is proposed, such as liquid crystal display panels of in-plane switching (IPS) mode and fringe field switching (FFS) mode. A liquid crystal display panel of the IPS mode or FFS mode generally comprises upper and lower substrates and a liquid crystal layer arranged between the upper and lower substrates. The lower substrate comprises thereon a plurality of horizontal gate lines and a plurality of vertical data lines intersecting each other to define a plurality of pixel zones and common electrodes and pixels are arranged in the pixel zones. A major feature is that the common electrode and the pixel electrode are both arranged on the lower substrate and a horizontal electric field established between the common electrode and the pixel electrode is used to control the rotation of the liquid crystal of the liquid crystal layer.

However, in an outdoor environment, many users often wear polarizer sunglasses to protect eyes from intense sunlight and thus also watch images displayed on the liquid crystal display screen through the polarizer sunglasses. The polarizer sunglasses generally comprise a polarizer element having a transmission axis in the horizontal direction and the vertical direction. Under such a condition, the IPS mode or FFS mode liquid crystal display panel may cause deterioration of visibility with the angle at which a user observes the screen.

### SUMMARY OF THE INVENTION

An object of the present invention is to provide a liquid crystal display panel, which improves visibility of an image displayed on the liquid crystal display panel and ensures that the visibility of an image displayed on the liquid crystal display panel is not affected when a user observes the displayed image through a polarizer element, such as polarizer sunglasses.

To achieve the above object, the present invention provides a liquid crystal display panel, which comprises: an array substrate and a plurality of thin-film transistors, common electrodes, pixel electrodes, a plurality of data lines, and a plurality of gate lines arranged on the array substrate;

the plurality of data lines being arranged parallel with and spaced from each other in a first direction, the plurality of gate lines being arranged parallel with and spaced from each other in a second direction that is perpendicular to the first direction, the plurality of data lines and the plurality of gate lines intersecting each other to define a plurality of pixel zones on the array substrate, each of the pixel zones comprising therein a thin-film transistor and a pixel electrode;

each of the data lines comprising:

a slope section, where the slope section extends, within the pixel zone, in a direction that is different from the first direction and the second direction and is inclined with respect to the second direction;

a horizontal section, where the horizontal section is connected to an upper end of the slope section and extends leftward from the upper end in the first direction; and

a connection section, where the connection section extends upward from the upper end of the slope section in the second direction and then extends rightward in the first direction to then extend downward in the second direction to connect to a source of the thin-film transistor;

each of the gate lines extending, within the pixel zone, in a direction that is different from the first direction and the second direction and is inclined with respect to the first direction;

the pixel electrodes each comprising:

two trunks that are parallel with the gate lines; and

a plurality of branches that are parallel with the slope section of the data line and are interposed between the two trunks, the plurality of branches being arranged parallel with and spaced from each other in the first direction.

Each of the gate lines is electrically connected to a gate of the corresponding thin-film transistor and each of the pixel electrodes is electrically connected to a drain of the corresponding thin-film transistors.

The liquid crystal display panel further comprises: a color filter substrate arranged opposite to the array substrate, a liquid crystal layer arranged between the array substrate and the color filter substrate, an incidence polarizer arranged on a side of the array substrate that is opposite to the color filter substrate, an exit polarizer arranged on a side of the color filter substrate that is opposite to the array substrate, a first insulation layer arranged between the array substrate and the data lines, a second insulation layer arranged between the data lines and the common electrode, a third insulation layer arranged between the common electrode and the pixel electrode, and a color filter arranged on a side of the color filter substrate that faces the array substrate.

The liquid crystal layer contains liquid crystal molecules having an orienting direction that is inclined with respect to the first direction or the second direction.

The incidence polarizer has a transmission axis in a direction that is identical to the orienting direction of the liquid crystal molecules and the exit polarizer has a transmission axis in a direction that is perpendicular to the orienting direction of the liquid crystal molecules.

The inclination angle of the slope section of the data lines and the branches of the pixel electrode with respect to the second direction is in a range of 2°≦α≦45° and the inclination angle of the gate lines with respect to the first direction is in the range of 2°≦β≦45°.

An inclination angle of an orienting direction of the liquid crystal molecules with respect to the slope section of the data lines is in the range of 2°≦θ≦45°.

The inclination angle of the slope section of the data lines and the branches of the pixel electrode with respect to the second direction is 45° and the inclination angle of the gate lines with respect to the first direction is 45°.

The color filter comprises a red color filter, a green color filter, and a blue color filter that are sequentially arranged.

The array substrate and the color filter substrate are transparent substrates.

The present invention also provides a liquid crystal display panel, which comprises: an array substrate and a plurality of thin-film transistors, common electrodes, pixel electrodes, a plurality of data lines, and a plurality of gate lines arranged on the array substrate;

the plurality of data lines being arranged parallel with and spaced from each other in a first direction, the plurality of gate lines being arranged parallel with and spaced from each other in a second direction that is perpendicular to the first direction, the plurality of data lines and the plurality of gate lines intersecting each other to define a plurality of pixel zones on the array substrate, each of the pixel zones comprising therein a thin-film transistor and a pixel electrode;

each of the data lines comprising:

a slope section, where the slope section extends, within the pixel zone, in a direction that is different from the first direction and the second direction and is inclined with respect to the second direction;

a horizontal section, where the horizontal section is connected to an upper end of the slope section and extends leftward from the upper end in the first direction; and

a connection section, where the connection section extends upward from the upper end of the slope section in the second direction and then extends rightward in the first direction to then extend downward in the second direction to connect to a source of the thin-film transistor;

each of the gate lines extending, within the pixel zone, in a direction that is different from the first direction and the second direction and is inclined with respect to the first direction;

the pixel electrodes each comprising:

two trunks that are parallel with the gate lines; and

a plurality of branches that are parallel with the slope section of the data line and are interposed between the two trunks, the plurality of branches being arranged parallel with and spaced from each other in the first direction;

wherein each of the gate lines is electrically connected to a gate of the corresponding thin-film transistor, each of the pixel electrodes being electrically connected to a drain of the corresponding thin-film transistors;

further comprising: a color filter substrate arranged opposite to the array substrate, a liquid crystal layer arranged between the array substrate and the color filter substrate, an incidence polarizer arranged on a side of the array substrate that is opposite to the color filter substrate, an exit polarizer arranged on a side of the color filter substrate that is opposite to the array substrate, a first insulation layer arranged between the array substrate and the data lines, a second insulation layer arranged between the data lines and the common electrode, a third insulation layer arranged between the common electrode and the pixel electrode, and a color filter arranged on a side of the color filter substrate that faces the array substrate; and

wherein the inclination angle of the slope section of the data lines and the branches of the pixel electrode with respect to the second direction is in a range of 2°≦α≦45° and the inclination angle of the gate lines with respect to the first direction is in the range of 2°≦β≦45°.

The efficacy of the present invention is that the present invention provides a liquid crystal display panel, which comprises gate lines and data lines that are respectively inclined with respect to the first direction and the second direction and also comprises pixel electrodes having trunks parallel with the gate lines. Branches of the pixel electrodes are parallel with the slope sections of the data lines. Liquid crystal molecules are arranged to have an orienting direction that is different from the first direction or the second direction and is inclined with respect to the first direction or the second direction. An incidence polarizer and an exit polarizer that are arranged correspondingly have transmission axes in directions different from the first direction and the second direction, so that visibility of an image displayed on the panel is not affected as being observed by a user through a polarizer element, such as polarizer sunglasses, having a transmission axis in a direction that is identical to the first or second direction thereby improving the visibility of the image displayed on the liquid crystal display panel.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing.

In the drawing:

FIG. 1 is a cross-sectional view showing a liquid crystal display panel according to the present invention; and

FIG. 2 is a plan view showing a pixel zone of the liquid crystal display panel according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

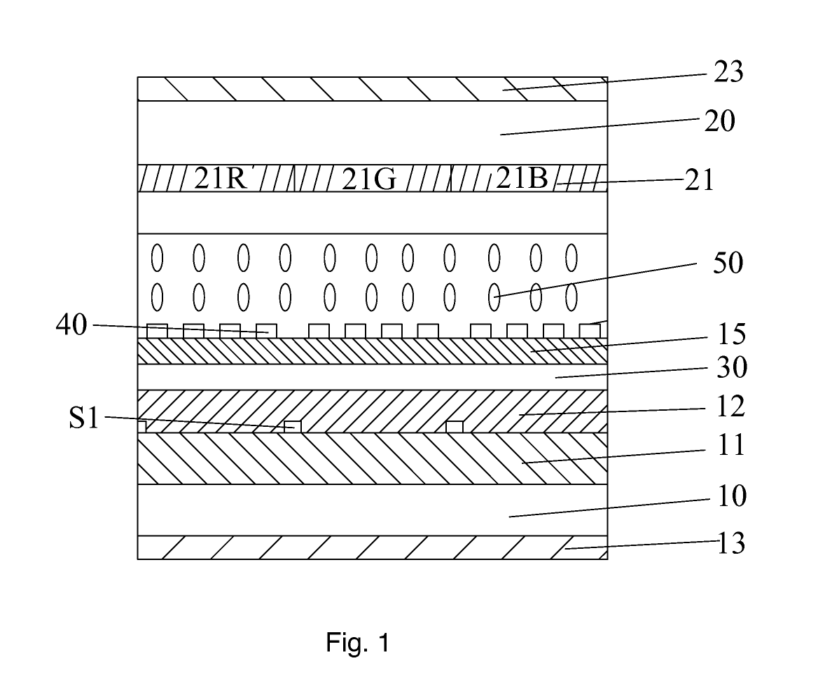

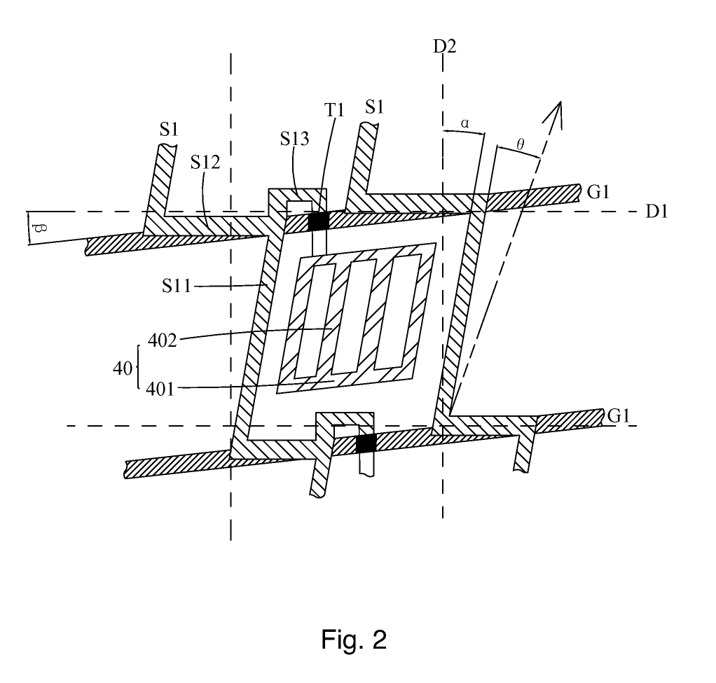

Referring to FIGS. 1 and 2, the present invention provides a liquid crystal display panel, which comprises: an array substrate 10 and a plurality of thin-film transistors T1, common electrodes 30, pixel electrodes 40, a plurality of data lines S1, and a plurality of gate lines G1 arranged on the array substrate.

The liquid crystal display panel further comprises: a color filter substrate 20 arranged opposite to the array substrate 10, a liquid crystal layer 50 arranged between the array substrate 10 and the color filter substrate 20, an incidence polarizer 13 arranged on a side of the array substrate 10 that is opposite to the color filter substrate 20, an exit polarizer 23 arranged on a side of the color filter substrate 20 that is opposite to the array substrate 10, a first insulation layer 11 arranged between the array substrate 10 and the data lines S1, a second insulation layer 12 arranged between the data lines S1 and the common electrode 30, a third insulation layer 15 arranged between the common electrode 30 and the pixel electrode 40, and a color filter 21 arranged on a side of the color filter substrate 20 that faces the array substrate 10.

The plurality of data lines S1 are arranged parallel with and spaced from each other in a first direction D1. The plurality of gate lines G1 are arranged parallel with and spaced from each other in a second direction D2 that is perpendicular to the first direction D1. The plurality of data lines S1 and the plurality of gate lines G1 intersect each other to define a plurality of pixel zones on the array substrate 10. Each pixel zone comprises therein a thin-film transistor T1 and a pixel electrode 40.

Specifically, in the present invention, each of the data lines S1 comprises: a slope section S11, where the slope section S11 extends, within the pixel zone, in a direction that is different from the first direction D1 and the second direction D2 and is inclined with respect to the second direction D2; a horizontal section S12, where the horizontal section S12 is connected to an upper end of the slope section S11 and extends leftward from the upper end in the first direction D1; a connection section S13, where the connection section S13 extends upward from the upper end of the slope section S11 in the second direction D2 and then extends rightward in the first direction D1 to then extend downward in the second direction D2 to connect to a source of the thin-film transistor T1.

Each of the gate lines G1 extends, within the pixel zone, in a direction that is different from the first direction D1 and the second direction D2 and is inclined with respect to the first direction D1. Each of the gate lines G1 is electrically connected to a gate of the corresponding thin-film transistor T1.

The pixel electrode 40 is electrically connected to a drain of the corresponding thin-film transistors T1 and comprises: two trunks 401 that are parallel with the gate lines G1 and a plurality of branches 402 that are parallel with the slope section S11 of the data line S1 and are interposed between the two trunks 401. The plurality of branches 402 are arranged parallel with and spaced from each other in the first direction D1.

The slope section S11 of the data lines S1 and the branches 402 of the pixel electrode 40 are inclined with respect to the second direction D2 by an inclination angle α having a range: 2°≦α≦45°; the gate lines G1 are inclined with respect to the first direction D1 by an inclination angle β having a range: 2°≦β≦45°. For inclination angle α or β less than 2°, no significant effect can be observed and for that angle greater than 45°, light transmittance may be affected.

Further, orienting direction of the liquid crystal molecules contained in the liquid crystal layer 50 is inclined with respect to the first direction D1 or the second direction D2. Specifically, the orienting direction of the liquid crystal molecules is inclined with respect to the slope section S11 of the data lines S1 by an inclination angle θ having a range: 2°≦θ≦45°. Correspondingly, the incidence polarizer 13 is arranged to have the direction of a transmission axis thereof identical to the orienting direction of the liquid crystal molecules and the exit polarizer 23 is arranged to have the direction of a transmission axis thereof perpendicular to the orienting direction of the liquid crystal molecules. Under this condition, the directions of the transmission axes of the incidence polarizer 13 and the exit polarizer 23 are different from the first direction and the second direction, so that the visibility of an image displayed on the panel is not affected as being observed by a user through a polarizer element, such as polarizer sunglasses, having a transmission axis that is identical to the first or second direction thereby improving the visibility of the image displayed on the liquid crystal display panel.

Preferably, the inclination angle α of the inclination of the slope section S11 of the data lines S1 and the branches 402 of the pixel electrode 40 with respect to the second direction D2 is 45°; the inclination angle β of the inclination of the gate lines G1 with respect to the first direction D1 is 45°. Under this condition, for a user observing light emitting from the exit polarizer 23 of the liquid crystal display panel through a polarizer element, such as polarizer sunglasses, having a transmission axis in a direction identical to the first or second direction, the visibility is best when the liquid crystal display panel is in a condition of being set the horizontal or vertical direction.

The color filter 21 comprises a red color filter 21R, a green color filter 21G, and a blue color filter 21B, which are sequentially arranged. Light from a backlighting source, after transmitting through the color filter 21 of the three colors, is turned into light of different colors of red, green, and blue.

The array substrate 10 and the color filter substrate 20 are both transparent substrates.

The common electrode 30 and the pixel electrode 40 are both transparent indium tin oxide (ITO) electrodes.

In summary, the present invention provides a liquid crystal display panel, which comprises gate lines and data lines that are respectively inclined with respect to the first direction and the second direction and also comprises pixel electrodes having trunks parallel with the gate lines. Branches of the pixel electrodes are parallel with the slope sections of the data lines. Liquid crystal molecules are arranged to have an orienting direction that is different from the first direction or the second direction and is inclined with respect to the first direction or the second direction. An incidence polarizer and an exit polarizer that are arranged correspondingly have transmission axes in directions different from the first direction and the second direction, so that visibility of an image displayed on the panel is not affected as being observed by a user through a polarizer element, such as polarizer sunglasses, having a transmission axis in a direction that is identical to the first or second direction thereby improving the visibility of the image displayed on the liquid crystal display panel.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A liquid crystal display panel, comprising: an array substrate and a plurality of thin-film transistors, common electrodes, pixel electrodes, a plurality of data lines, and a plurality of gate lines arranged on the array substrate;
the plurality of data lines being arranged parallel with and spaced from each other in a first direction, the plurality of gate lines being arranged parallel with and spaced from each other in a second direction that is perpendicular to the first direction, the plurality of data lines and the plurality of gate lines intersecting each other to define a plurality of pixel zones on the array substrate, each of the pixel zones comprising therein a thin-film transistor and a pixel electrode;
each of the data lines comprising:
a slope section, where the slope section extends, within the pixel zone, in a direction that is different from the first direction and the second direction and is inclined with respect to the second direction;
a horizontal section, where the horizontal section is connected to an upper end of the slope section and extends leftward from the upper end in the first direction; and
a connection section, where the connection section extends upward from the upper end of the slope section in the second direction and then extends rightward in the first direction to then extend downward in the second direction to connect to a source of the thin-film transistor;
each of the gate lines extending, within the pixel zone, in a direction that is different from the first direction and the second direction and is inclined with respect to the first direction;
the pixel electrodes each comprising:
two trunks that are parallel with the gate lines; and
a plurality of branches that are parallel with the slope section of the data line and are interposed between the two trunks, the plurality of branches being arranged parallel with and spaced from each other in the first direction

2. The liquid crystal display panel as claimed in claim 1, wherein each of the gate lines is electrically connected to a gate of the corresponding thin-film transistor, each of the pixel electrodes being electrically connected to a drain of the corresponding thin-film transistors.

3. The liquid crystal display panel as claimed in claim 1 further comprising: a color filter substrate arranged opposite to the array substrate, a liquid crystal layer arranged between the array substrate and the color filter substrate, an incidence polarizer arranged on a side of the array substrate that is opposite to the color filter substrate, an exit polarizer arranged on a side of the color filter substrate that is opposite to the array substrate, a first insulation layer arranged between the array substrate and the data lines, a second insulation layer arranged between the data lines and the common electrode, a third insulation layer arranged between the common electrode and the pixel electrode, and a color filter arranged on a side of the color filter substrate that faces the array substrate.

4. The liquid crystal display panel as claimed in claim 3, wherein the liquid crystal layer contains liquid crystal molecules having an orienting direction that is inclined with respect to the first direction or the second direction.

5. The liquid crystal display panel as claimed in claim 4, wherein the incidence polarizer has a transmission axis in a direction that is identical to the orienting direction of the liquid crystal molecules and the exit polarizer has a transmission axis in a direction that is perpendicular to the orienting direction of the liquid crystal molecules.

6. The liquid crystal display panel as claimed in claim 1, wherein the inclination angle of the slope section of the data lines and the branches of the pixel electrode with respect to the second direction is in a range of 2°≦α≦45° and the inclination angle of the gate lines with respect to the first direction is in the range of 2°≦β≦45°.

7. The liquid crystal display panel as claimed in claim 3, wherein an inclination angle of an orienting direction of the liquid crystal molecules with respect to the slope section of the data lines is in the range of 2≦θ≦45°.

8. The liquid crystal display panel as claimed in claim 5, wherein the inclination angle of the slope section of the data lines and the branches of the pixel electrode with respect to the second direction is 45° and the inclination angle of the gate lines with respect to the first direction is 45°.

9. The liquid crystal display panel as claimed in claim 3, wherein the color filter comprises a red color filter, a green color filter, and a blue color filter that are sequentially arranged.

10. The liquid crystal display panel as claimed in claim 3, wherein the array substrate and the color filter substrate are transparent substrates.

11. A liquid crystal display panel, comprising: an array substrate and a plurality of thin-film transistors, common electrodes, pixel electrodes, a plurality of data lines, and a plurality of gate lines arranged on the array substrate;
the plurality of data lines being arranged parallel with and spaced from each other in a first direction, the plurality of gate lines being arranged parallel with and spaced from each other in a second direction that is perpendicular to the first direction, the plurality of data lines and the plurality of gate lines intersecting each other to define a plurality of pixel zones on the array substrate, each of the pixel zones comprising therein a thin-film transistor and a pixel electrode;
each of the data lines comprising:
a slope section, where the slope section extends, within the pixel zone, in a direction that is different from the first direction and the second direction and is inclined with respect to the second direction;
a horizontal section, where the horizontal section is connected to an upper end of the slope section and extends leftward from the upper end in the first direction; and
a connection section, where the connection section extends upward from the upper end of the slope section in the second direction and then extends rightward in the first direction to then extend downward in the second direction to connect to a source of the thin-film transistor;
each of the gate lines extending, within the pixel zone, in a direction that is different from the first direction and the second direction and is inclined with respect to the first direction;
the pixel electrodes each comprising:
two trunks that are parallel with the gate lines; and
a plurality of branches that are parallel with the slope section of the data line and are interposed between the two trunks, the plurality of branches being arranged parallel with and spaced from each other in the first direction;
wherein each of the gate lines is electrically connected to a gate of the corresponding thin-film transistor, each of the pixel electrodes being electrically connected to a drain of the corresponding thin-film transistors;
further comprising: a color filter substrate arranged opposite to the array substrate, a liquid crystal layer arranged between the array substrate and the color filter substrate, an incidence polarizer arranged on a side of the array substrate that is opposite to the color filter substrate, an exit polarizer arranged on a side of the color filter substrate that is opposite to the array substrate, a first insulation layer arranged between the array substrate and the data lines, a second insulation layer arranged between the data lines and the common electrode, a third insulation layer arranged between the common electrode and the pixel electrode, and a color filter arranged on a side of the color filter substrate that faces the array substrate; and
wherein the inclination angle of the slope section of the data lines and the branches of the pixel electrode with respect to the second direction is in a range of 2°≦α≦45° and the inclination angle of the gate lines with respect to the first direction is in the range of 2°≦β≦45°.

12. The liquid crystal display panel as claimed in claim 11, wherein the liquid crystal layer contains liquid crystal molecules having an orienting direction that is inclined with respect to the first direction or the second direction.

13. The liquid crystal display panel as claimed in claim 12, wherein the incidence polarizer has a transmission axis in a direction that is identical to the orienting direction of the liquid crystal molecules and the exit polarizer has a transmission axis in a direction that is perpendicular to the orienting direction of the liquid crystal molecules.

14. The liquid crystal display panel as claimed in claim 11, wherein an inclination angle of an orienting direction of the liquid crystal molecules with respect to the slope section of the data lines is in the range of 2°≦θ≦45°.

15. The liquid crystal display panel as claimed in claim 11, wherein the inclination angle of the slope section of the data lines and the branches of the pixel electrode with respect to the second direction is 45° and the inclination angle of the gate lines with respect to the first direction is 45°.
